(19) United States
(12) Patent Application Publication
(10) Pub. No.: US 2013/0334014 A1
(43) Pub. Date: Dec. 19, 2013

(54) IMAGE FORMING APPRATUS

(71) Applicants: Kenichi Mashiko, Shizuoka (JP); Jun Aoto, Kanagawa (JP)

(72) Inventors: Kenichi Mashiko, Shizuoka (JP); Jun Aoto, Kanagawa (JP)

(73) Assignee: RICOH COMPANY, LTD., Tokyo (JP)

(21) Appl. No.: 13/901,945

(22) Filed: May 24, 2013

(30) Foreign Application Priority Data
Jun. 15, 2012 (JP) 2012-135890

(51) Int. Cl. B65G 15/32

(52) U.S. Cl. CPC B65G 15/32
USPC 198/847

(57) ABSTRACT

An image forming apparatus includes a belt member including a substrate; and an elastic layer overlying the substrate, an image former forming an image on the surface of the belt member or a recording material borne thereon, and a contact member contacting the surfaces of both ends of the belt member in its width direction, wherein the contact member has a hardness not greater than 30 when measured by Durometer Type C in an environment of 23° C. and 50% RH.

### CROSS-REFERENCE TO RELATED APPLICATIONS

This patent application is based on and claims priority pursuant to 35 U.S.C. §119 to Japanese Patent Application No. 2012-135890, filed on Jun. 15, 2012, in the Japan Patent Office, the entire disclosure of which is hereby incorporated by reference herein.

### BACKGROUND OF THE INVENTION

1. Field of the Invention

The present invention relates to an age forming apparatus such as printers, facsimiles and copiers.

2. Description of the Related Art

An image forming apparatus using an intermediate transfer belt which is a belt member is effectively used as a full-color image forming apparatus or a multicolor image forming apparatus sequentially transferring plural color component images such as color image information and multicolor image information in a layer to produce color prints. Conventionally, the intermediate transfer belts are mostly formed of a resin such as polyimide resins and polyamideimide resins.

However, the intermediate transfer belt formed of a resin typically has high hardness. Therefore, in a first transfer process in which a toner image is transferred from a photoreceptor as an image bearer to the intermediate transfer belt, and in a second in which a toner image is transferred from the intermediate transfer belt to a recording medium, the toner image, particularly the center thereof, receives stress most, resulting in defective transfer, i.e., hollow images.

As one of methods improving the hollow images, e.g., Japanese published unexamined applications Nos. JP-2009-223282-A and JP-2011-197190-A disclose a method of elasticizing the surface of the intermediate transfer belt. Namely, the intermediate transfer belt having an elastic surface is freely transformed according to the thickness of a toner image, and the toner image receives less stress. Therefore, in order to eliminate the defective transfer, an intermediate transfer belt including an elastic layer formed of a flexible material such as rubbers overlying a substrate is used.

Japanese published unexamined applications Nos. JP-2002-196593-A and JP-2009-244331-A disclose a cleaning member removing a toner remaining on the intermediate transfer belt after a toner image is transferred therefrom and a seal member contacting both ends of the intermediate transfer belt in its width direction not to scatter a toner. However, the elastic layer forming the surface of the intermediate transfer belt has poor abrasion resistance, and is abraded due to friction with the seal member. When the elastic layer is abraded, the elastic material component therefrom contacts a photoreceptor, resulting in hollow images. In addition, when the end of the belt in its width direction is abraded, contact state between the seal member and the intermediate transfer belt varies and the intermediate transfer belt runs unstably, resulting in distortion of the resultant images.

Japanese published unexamined application No. JP-2009-48032-A discloses an intermediate transfer belt without elastic layers on both ends thereof in its width direction. Therefore, the elastic layer is not abraded due to friction with the seal member. However, the thickness of both ends thereof are extremely thin and the intermediate transfer belt is unbalanced, resulting in unstable running thereof. Further, when the cleaning member applied with a bias removes a toner remaining on the intermediate transfer belt, the bias leaks from both ends thereof without an elastic layer, resulting in defective cleaning.

Japanese published unexamined application No. JP-2009-300490-A discloses an intermediate transfer belt in which a reinforcing member having more abrasion resistance than the elastic layer is attached with an adhesive such as double-stick tapes on an elastic layer of both ends of which in its width direction. The seal member preventing a toner from scattering when the intermediate transfer belt is cleaned contacts the reinforcing member to prevent the elastic layer from abrading.

However, the reinforcing member possibly peels off from the elastic layer because of deterioration of the adhesive when used for long periods, and the exposed elastic layer is possibly abraded due to friction with the seal member.

Other belts used in image forming apparatus such as photoreceptor belts and recording material transfer belts have the same problems.

Because of these reasons, a need exists for an image forming apparatus preventing an elastic layer on an end of each belt used therein from being abraded for long periods.

### SUMMARY OF THE INVENTION

Accordingly, one object of the present invention to provide an image forming apparatus preventing an elastic layer on an end of each belt used therein from being abraded for long periods.

These objects and other objects of the present invention, either individually or collectively, have been satisfied by the discovery of an image forming apparatus, comprising:

a belt member, comprising:
a substrate; and
an elastic layer overlying the substrate,

an image former configured to form an image on the surface of the belt member or a recording material borne thereon, and

a contact member configured to contact the surface of each end of the belt member n its width direction,

wherein the contact member has a hardness not greater than 30 when measured by Durometer Type C in an environment of 23° C. and 50% RH.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating a positional cross-section of an intermediate transferer and a cleaning unit in the present invention;

FIG. 2 is a schematic view illustrating an embodiment of the image forming apparatus including an intermediate transfer belt of the present invention;

FIG. 3 is a schematic view illustrating another embodiment of the image forming apparatus including an intermediate transfer belt of the present invention;

FIG. 4 is a schematic view illustrating an embodiment of layer structure of an intermediate transfer belt in the present invention;

FIG. 5 is an amplified schematic view illustrating the intermediate transfer belt viewed from straight above;

FIG. 6 is a schematic view illustrating a cross-section of an intermediate transfer belt having a surface layer including plural particles;

FIG. 7 is a schematic view illustrating an apparatus for coating a substrate layer and an elastic layer;

FIG. 8 is a schematic view illustrating an apparatus for coating and fixing a spherical particulate resin (particulate powder); and

FIG. 9 is a schematic view illustrating an embodiment of contact member in the present invention.

### DETAILED DESCRIPTION OF THE INVENTION

The present invention provides an image forming apparatus preventing an elastic layer on an end of each belt used therein from being abraded for long periods.

More particularly, the present invention relates to an image forming apparatus, comprising:

a belt member, comprising:
a substrate; and
an elastic layer overlying the substrate,

an image former configured to form an image on the surface of the belt member or a recording material borne thereon, and

a contact member configured to contact the surface of each end of the belt member in its width direction,

wherein the contact member has a hardness not greater than 30 when measured by Durometer Type C in an environment of 23° C. and 50% RH.

Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

FIG. 2 is a schematic view illustrating an embodiment of the image forming apparatus including a seamless belt as an intermediate transfer belt 501 of the present invention.

An intermediate transfer unit 500 is formed of the intermediate transfer belt 501 rotatably suspended by plural rollers with tension, etc. Around the intermediate transfer belt 501, a second bias roller 605 of a second transfer unit 600, a belt cleaning blade 504, a lubricant application brush 505, etc. are located.

An unillustrated position detection mark is formed on an outer or an inner circumferential surface of the intermediate transfer belt 501. However, the position detection mark needs to be out of a passing area of the belt cleaning blade 504 when formed on the outer circumferential surface of the intermediate transfer belt 501. In this case, he position detection mark is formed on the inner circumferential surface thereof. An optical sensor 514 as a mark detection sensor is located between a first transfer bias roller 507 and a belt drive roller 508 the intermediate transfer belt 501 is suspended over.

The intermediate transfer belt 501 is rotatably suspended by the first transfer bias roller 507, the belt drive roller 508, a belt tension roller 509, a second transfer opposed roller 510, a cleaning opposed runner 511 and a feed-back current detection roller 512. Each roller is formed of an electroconductive material and earthed except for the first transfer bias roller 507. The first transfer bias roller 507 is applied with a transfer bias having a predetermined current or a voltage according to the number of overlapped toner images by a first transfer electric source 801 controlled to have a specific current or a specific voltage.

The intermediate transfer belt 501 is driven in the direction of an arrow by the belt drive roller 508 rotationally driven in the direction of an arrow by an unillustrated drive motor.

The intermediate transfer belt 501 has a multilayered structure including a substrate layer and an elastic layer overlying the substrate layer, a seamless belt having no seam in its surface travelling direction is preferably used therefor. This improves durability thereof and produces quality images. In addition, the intermediate transfer belt 501 is larger than a maximum size of a paper passable because of overlapping toner images formed on a photoreceptor drum 200.

A second transfer bias roller 605 as a second transferer is contactably and separably located by a contactor and separator mentioned later to an outer circumferential surface of the intermediate transfer belt 501 suspended by the second transfer opposed roller 510 with tension. The second transfer bias roller 605 sandwiches a transfer paper P with the outer circumferential surface of the intermediate transfer belt 501 suspended by the second transfer opposed roller 510. A second transfer electric source 802 controlled to have a specific current applies a transfer bias having a predetermined current to the second transfer bias roller 605.

A pair of registration rollers 610 feeds a transfer paper P between the outer circumferential surface of the intermediate transfer belt 501 and the second transfer bias roller 605 at a predetermined timing. A cleaning blade 608 as a cleaner contacts the second transfer bias roller 605. The cleaning blade 608 removes materials adhering to the surface of the second transfer bias roller 605 to clean.

When image forming cycle is started in a full-color copier having such a constitution, the photoreceptor drum 200 is rotated by an unillustrated drive motor anticlockwise in the direction of an arrow. Toner images having black (Bk), cyan (C), magenta (M) and yellow (Y) colors, respectively are sequentially formed on the photoreceptor drum 200.

The intermediate transfer belt 501 is rotated by the belt drive roller 508 clockwise in the direction of an arrow. While the intermediate transfer belt 501 is rotated, a transfer bias applied to the first transfer bias roller 507 first transfers the toner images having respective colors from the photoreceptor drum 200 onto the intermediate transfer belt 501. Finally, the Bk, C, M and Y color toner images are overlapped in this order thereon.

For example, a black (Bk) toner image is formed as follows.

In FIG. 2, a charger 203 negatively charges the surface of the photoreceptor drum 200 with uniformity by a corona discharge. Based on the belt mark detection signal, the uniformly-charged surface of the photoreceptor drum 200 is subjected to a raster exposure with a laser beam by an unillustrated optical unit, based on a Bk color image signal. The exposed part of the surface of the photoreceptor drum 200 loses a charge proportional to the exposure amount and a Bk electrostatic latent image is formed thereon. A negatively-charged black toner on a developing roller of an image developer 231Bk contacts the Bk electrostatic latent image and adsorb thereto to form a Bk toner image equivalent thereto.

Thus, the Bk toner image formed on the photoreceptor drum 200 is first transferred onto an outer circumferential surface of the intermediate transfer belt 501 driven to rotate at a constant speed while contacting the photoreceptor drum 200.

A residual toner untransferred remaining on the surface of the photoreceptor drum 200 after the first transfer is removed therefrom by a photoreceptor cleaner 201 for the photoreceptor drum 200 to be prepared to form a following image.

The process of forming a Bk toner image is followed by a process of forming a C toner image. A color scanner starts reading a C image data and laser beam writing based thereon forms a C electrostatic latent image on the surface of the photoreceptor drum 200.

After a rear end of the Bk electrostatic latent image passes, and a fore end of the C electrostatic latent image reaches, a revolver developing unit 230 rotates and an image developer 231C is set at a developing position to develop the C electrostatic latent image with a C toner. Then, when a rear end of the C electrostatic latent image passes, the revolver developing unit rotates and an image developer 231M is set at a developing position. This is completed before a fore end of a following Y electrostatic latent image reaches.

Since a M toner image forming process and a Y toner image forming process are the same as those of forming the Bk toner image and the C toner image, and explanations thereof are omitted.

The Bk, C, M and Y toner images sequentially formed on the photoreceptor drum 200 are first transferred onto the same surface of the intermediate transfer belt 501, the positions of which are sequentially adjusted. Thus, at most four color toner images are overlapped on the intermediate transfer belt 501. On the other hand, when the image forming process starts, a transfer paper P is fed from a transfer paper cassette or a manual paper feed tray and stands by at a nip of a pair of registration rollers 610.

The image forming apparatus includes a second transfer part where a nip is formed between a part of the intermediate transfer belt 501 suspended by the second transfer opposed roller 510 and the second transfer roller 605. When an end of a toner image on the intermediate transfer belt 501 reaches the second transfer part, a pair of the registration rollers 610 are driven to adjust an end of the transfer paper P to the end of the toner image. Then, the transfer paper P is transferred along a transfer paper guide plate 601 and a registration between the transfer paper P and the toner image is adjusted.

When the transfer paper P passes the second transfer part, a transfer bias by a voltage applied to the second transfer roller 605 by the second transfer electric source 802 (secondly) transfers the overlapped four color toner images on the intermediate transfer belt 501 onto the transfer paper P at a time. The transfer paper P is transferred along the transfer paper guide plate 601 and passes an opposite part to a transfer paper discharger 606 formed of a discharge needle and located downstream from the second transfer part to be discharged. Then, a belt conveyor 210 conveys the transfer paper P to a fixer 270. After a toner image is melted and fixed on the transfer paper P at a nip between a heat roller 271 and a pressure roller 272 of the fixer 270, the transfer paper P is fed out of the apparatus by an unillustrated discharge roller and stacked on an unillustrated copy tray with an image side up.

Meanwhile, the surface of the photoreceptor drum 200 after a toner image is transferred onto the intermediate transfer belt 501 is cleaned by the photoreceptor cleaner 201 and uniformly discharged by a discharge lamp 202. In addition, a residual toner remaining on an outer circumferential surface of the intermediate transfer belt 501 after a toner image is second transferred onto the transfer paper P is removed by the belt cleaning blade 504 in a belt cleaner 503, contacting an end thereof to the surface of the intermediate transfer belt. The belt cleaning blade 504 is contacted to and separated from the outer circumferential surface of the intermediate transfer belt 501 at a predetermined timing by an unillustrated cleaning member contactor and separator.

The belt cleaner 503 includes a toner seal member 502 contacting the surfaces of both edges of the intermediate transfer belt in its width direction. The toner seal member 502 prevents a toner from going out of the belt cleaner 503 and scattering on a conveyance route of the transfer paper P.

A lubricant 506 scraped off by the lubricant application brush 505 is applied to the outer circumferential surface of the intermediate transfer belt 501 a residual toner is removed from. The lubricant 506 is formed of a sold material such as zinc stearate and located to contact the lubricant application brush 505. In addition, a residual charge remaining on the outer circumferential surface of the intermediate transfer belt 501 is removed by a discharge bias applied by an unillustrated belt discharge brush contacting the outer circumferential surface of the intermediate transfer belt 501. The lubricant application brush 505 and the belt discharge brush are contacted to and separated from the outer circumferential surface of the intermediate transfer belt 501 at predetermined timings by respective unillustrated contactors and separators.

When a copy is repeatedly produced, the fourth (Y) color image forming process of the first image is followed by operation of a color scanner and image formation on the photoreceptor drum 200 of the first color image (Bk) of the second image at a predetermined timing. A Bk toner image of the second image is first transferred onto a part cleaned by the belt cleaning blade 504 of the intermediate transfer belt 501, which is followed by the transfer process of the overlapped four color toner images of the first image onto a transfer paper at a time. Then, the process is same as the first image afterwards. Full-color copy mode using four colors has been explained. The same processes are performed for the number of colors, e.g., in three-color copy mode and two-color copy mode. In single-color copy mode, only an image developer for a single color of the revolver developing unit 230 works while the belt cleaning blade 504 is kept to contact the intermediate transfer belt 501.

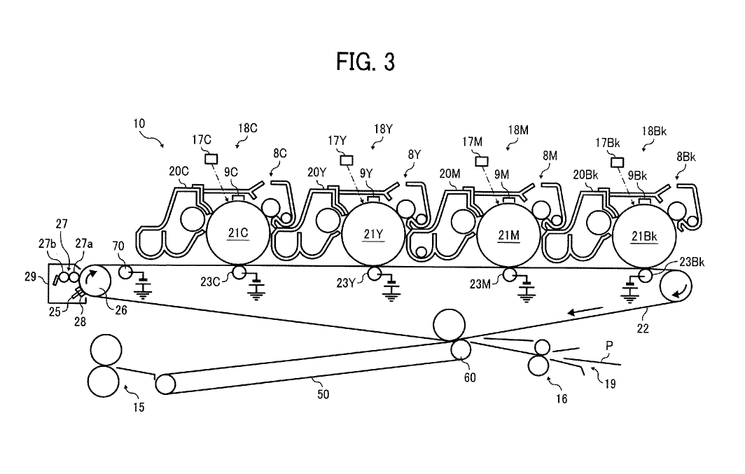

A copier including only one photoreceptor drum has been explained, and the present invention can be used in an image forming apparatus such as an embodiment in FIG. 3, including plural photoreceptor drums along an intermediate transfer belt 22 formed of a seamless belt.

FIG. 3 is a four-drum digital color printer including four photoreceptor drums 21Bk, 21Y, 21M and 21C forming toner images having four different colors, i.e., black (Bk), magenta (M), yellow (Y) and cyan (C). In FIG. 3, a printer 10 includes image writers 17Bk, 17M, 17Y, and 17C, image formers 18Bk, 18M, 18Y and 18C, a paper feeder 19, etc. for forming color images. An image processor converts an image signal to each black, magenta, yellow and cyan color signal, and transmits the signals to the image writer 17. The image writer 17 is a laser scanning optical system formed of a laser light source, a deflector such as a polygon mirror, a scanning imaging optical system and mirrors. The printer also includes four writing light paths for each color signal and writes images according thereto on the photoreceptor drums 21Bk, 21Y, 21M and 21C as image bearers for each color in the image formers 18Bk, 18M, 18Y and 18C.

The image formers 18Bk, 18M, 18Y and 18C include the photoreceptor drums 21Bk, 21Y, 21M and 21C as image bearers for each color i.e., black (Bk), magenta (M), yellow (Y) and cyan (C). OPC photoreceptors are typically used as the photoreceptor drums 21Bk, 21Y, 21M and 21C.

Around each of the photoreceptor drums 21Bk, 21Y, 21M and 21C, a charger 9, a laser beam irradiator of the image writer 17, an image developer 20, a first transfer bias roller 23, a cleaner 8, a discharger (unillustrated) are located. Each of the image developers 20Bk, 20M, 20Y and 20C uses a two-component magnetic brush method using a two-component developer including a toner and a carrier.

The intermediate transfer belt 22 is located between each of the photoreceptor drums 21Bk, 21Y, 21M and 21C and each of first transfer bias rollers 23Bk, 23M, 23Y and 23C. Color toner images formed on respective photoreceptor drums 21Bk, 21Y, 21M and 21C are transferred onto the intermediate transfer belt 22 to be sequentially overlapped.

Meanwhile, a transfer paper P is borne on the surface of a transfer conveyance belt 50 through a pair of the registration rollers 16 after fed from the paper feeder 19. The transfer conveyance belt 50 conveys the transfer paper P to contact the transfer paper P to the intermediate transfer belt 22. Toner images of each color thereon are secondly transferred onto the transfer paper P by a second transfer bias roller 60 at a time to form a color image. The transfer paper P a color image is formed on is conveyed by the transfer conveyance belt 50 to a fixer 15. After the color image on the transfer paper P is fixed thereon by the fixer 15, the transfer paper P is discharged out of the printer.

A residual toner remaining on the intermediate transfer belt 22, which is untransferred in the second transfer is removed therefrom by a belt cleaner 29 including a belt cleaning blade 25 contacting an end thereof to the surface of the intermediate transfer belt. A lubricant applicator 27 is located at a downstream side of the surface travel direction of the intermediate transfer belt from the belt cleaning blade 25. The lubricant applicator 27 is formed of a solid lubricant 27b and a rotatable electroconductive brush 27a scraping the solid lubricant 27b to apply the lubricant to the intermediate transfer belt 22. The electroconductive brush 27a constantly contacts the intermediate transfer belt 22 to apply the solid lubricant 27b thereto. The solid lubricant 27b increases cleanability of the intermediate transfer belt 22 and improves durability, preventing filming.

A toner seal member 28 contacts both ends of the intermediate transfer belt in its width direction to prevent a toner scattering out of the belt cleaner 29 when the belt cleaning belt 25 cleans the belt.

Seamless belts are used for some members in image forming apparatus, and the intermediate transferer (belt) is one of important members requiring electrical properties. Hereinafter, an intermediate transfer belt used in image forming apparatus of the present invention is explained. Exemplary embodiments of the present invention are described in detail below with reference to accompanying drawings. In describing exemplary embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner and achieve a similar result.

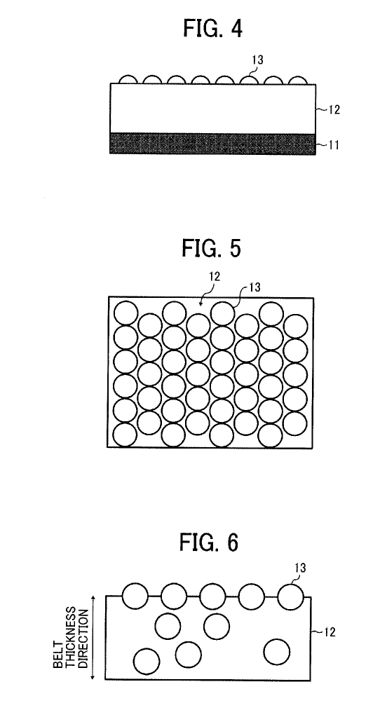

FIG. 4 is a schematic view illustrating an embodiment of layer structure of an intermediate transfer belt in the present invention. The layer structure is not limited thereto. A flexible elastic layer 12 is layered on a stiff substrate layer 11 having flexibility, and spherical particulate resins 13 are independently located (buried) at an outermost surface of the elastic layer 12 in the surface direction to form uniform concavities and convexities.

First, a substrate layer 11 is explained. The substrate layer 11 is formed of a resin including a filler (or an additive) controlling electric resistance, i.e., an electric resistance regulator. The resin is preferably fluorine-containing resins such as PVDF (polyvinylidene fluoride) and ETFE (Ethylene tetrafluoroethylene copolymer); and polyimide resins or polyamideimide resins in terms of flame resistance. Particularly, the polyimide resins or polyamideimide resins are more preferably used in terms of mechanical strength and heat resistance.

General-use polyimide resins or polyamideimide resins from Du Pont-Toray Co., Ltd., Ube Industries, Ltd., New Japan Chemical Co., Ltd., JSR Corp., Unitika, Ltd., I. S.T. Corp., Hitachi Chemical Co., Ltd., Toyobo Co., Ltd., Arakawa Chemical Industries, Ltd., etc. can be used.

Specific examples of the electric resistance regulator include metal oxides, carbon black, ion conductive agents, conductive polymers, etc. Specific examples of the metal oxides include zinc oxide, tin oxide, titanium oxide, zirconium oxide, aluminum oxide, silicon oxide, etc. The metal oxides may be surface-treated to improve their dispersibility.

Specific examples of the carbon black include ketchen black, furnace black, acetylene black, thermal black, gas black, etc. Specific examples of the ion conductive agents include tetraalkylammonium salts, trialkylbenzylammonium salts, alkylsulfonic acid salts, alkylbenzenesulfonic acid salts, alkylsulfates, glycerin fatty acid esters, sorbitan fatty acid esters, polyoxyethylenealkylamine, polyoxyethylene fatty acid alcohol esters, alkylbetaines, lithium perchlorate, etc. These can be used alone or in combination. The electric resistance regulators are not limited thereto in the embodiment.

In a method of preparing the intermediate transfer belt of the embodiment, a coating liquid includes a resin, and may further include a dispersion auxiliary agent, a stiffener, a lubricant, a thermally-conducting agent, an antioxidant, etc. when necessary.

A seamless belt preferably used as an intermediate transfer belt preferably includes an electric resistance regulator in an amount to have a surface resistivity of from 1×10⁸ to 1×10¹³ [Ω/□] and a volume resistivity of from 1×10⁵ to 1×10¹² [Ω/□]. However, in terms of mechanical strength, the amount needs to be large enough not to form a fragile and breakable film. Namely, the intermediate transfer belt is preferably a seamless belt having a good balance between electrical properties (surface and volume resistivities) and mechanical strength, formed with a coating liquid including proper contents of the resin, e.g., a polyimide resin precursor or a polyamide imide resin precursor) and the electric resistance regulator.

The coating liquid preferably includes the carbon black when used as the electric regulator in an amount of form 10 to 25% by weight, and more preferably from 15 to 20% by weight, based on total weight of solid contents therein. The coating liquid preferably includes the metal oxide when used as the electric regulator in an amount of form 1 to 50% by weight, and more preferably from 10 to 30% by weight, based on total weight of solid contents therein. When less than the respective minimum contents, the electric resistance is not effectively regulated. When greater than the respective maximum contents, the intermediate transfer belt (seamless belt) deteriorates in mechanical strength.

The substrate layer 11 preferably has a thickness of from 30 to 150 μm, more preferably from 40 to 120 μm, and furthermore preferably from 50 to 80 μm. When less than 30 μm, the belt is easy to tear with crack. When greater than 150 μm, the belt occasionally cracks when bent. When from 50 to 80 μm, the belt has higher durability. The substrate layer 11 preferably has no uneven thickness to improve running stability.

Methods of measuring the thickness are not particularly limited, and include measuring with a contact or an eddy current film thickness meter and measuring a cross-section of a film with a scanning electron microscope.

Next, an elastic layer 12 formed of an elastic material and layered on the substrate layer 11 is explained. The elastic layer 12 is layered on the substrate layer 11, includes spherical particulate resins 13 mentioned later, and concavities and convexities are formed thereon.

General-use resins, elastomers and rubbers can be used as the elastic material, and the elastomers and rubbers are preferably used because of having sufficient flexibility (elasticity) to execute an effect of the present invention.

Specific examples of the elastomers include thermoplastic elastomers such as polyester elastomers, polyamide elastomers, polyether elastomers, polyurethane elastomers, polyolefin elastomers, polystyrene elastomers, polyacrylic elastomers, polydiene elastomers, silicone-modified polycarbonate elastomers and fluorine-containing copolymer elastomers; and thermoset elastomers such as polyurethane elastomers, silicone-modified epoxy elastomers and silicone-modified acrylic elastomers.

Specific examples of the rubbers include isoprene rubbers, styrene rubbers, butadiene rubbers, nitrile rubbers, ethylenepropylene rubbers, butyl rubbers, silicone rubbers, chloroprene rubbers, acrylic rubbers, chlorosulfonated polyethylene, fluorine-containing rubbers, urethane rubbers, hydrin rubbers, etc,

Particularly, to follow a transfer medium having a concave and convex surface such as Leathac papers, the softer, the more preferable.

In this embodiment, the thermoset materials are more preferably used than thermoplastic materials to form a spherical particulate resin layer thereon. This is because thermoset materials have contact close with the spherical particulate resin 13, and which is firmly fixed thereon owing to an effect of a functional group for thermosetting. Vulcanized rubbers are preferably used as well.

In this embodiment, the acrylic rubbers are most preferably used in terms of ozone resistance, flexibility, adhesivenss with the spherical particulate resin 13, flame resistance and environment stability. Hereinafter, the acrylic rubbers are explained.

Marketed acrylic rubbers can be used, and are not particularly limited. However, among various acrylic rubbers crosslinked with various groups such as an epoxy group, an active chlorine group and a carboxyl group, acrylic rubbers crosslinked with a carboxyl group more preferably used because of having good rubber properties (compression set in particular) and processability.

Crosslinkers used for the acrylic rubbers crosslinked with a carboxyl group are preferably amine compounds, and most preferably polyamine compounds.

Specific examples of the amine compounds include aliphatic polyamine crosslinkers, aromatic polyamine crosslinkers, etc. Specific examples of the aliphatic polyamine crosslinkers include hexamethylenediamine, hexamethylenediamine carbamate, N,N′-dicinnamylidene-1,6-hexadiamine, etc.

Specific examples of the aromatic polyamine crosslinkers include 4,4′-methylenedianiline, m-phenylenediamine, 4,4′-diaminodiphenylether, 3,4′-diaminodiphenylether, 4,4′-(m-phenylenediisopropylidene)dianiline, 4,4′-(p-phenylenediisopropylidene)dianiline, 2,2′-bis[4-(4-aminophenoxy)phenyl]propane, 4,4′-diaminobenzanilide, 4,4′-bis(4-aminophenoxy)biphenyl, m-xylylenediamine, p-xylylenediamine, 1,3,5-benzenetriamine, 1,3,5-benzenetriaminomethyl, etc.

The acrylic rubber preferably includes the crosslinker in an amount of from 0.05 to 20 parts by weight, and more preferably from 0.1 to 5 parts by weight. When too little, the crosslinked rubber is difficult to keep its shape. When too much, the crosslinked rubber is too hard to have elasticity.

In the acrylic rubber elastic layer of this embodiment, a cross-linking promoter may be combined with the crosslinker. The cross-linking promoter is not particularly limited, but preferably combinable with the polyamine crosslinker. Specific examples of the cross-linking promoter include guanidine compounds such as 1,3-diphenylguanidine and 1,3-diorthotolylguanidine; imidazole compounds such as 2-methylimidazole and 2-phenylimidaazole; and quaternary onium salts such as tetra-n-butylammoniumbromide and octadecyltri-n-butykammoniumbromide; tertiary polyamine compounds such as triethylenediamine, 1,8-diaza-bicyclo[5,4,0]undecene-7(DBU); tertiary phosphine compounds such as triphenylphosphine and tri-p-tolylphosphine; and slightly acidic alkali metal salts such as sodium or potassium phosphate, inorganic slightly acidic salts, e.g., carbonates and organic slightly acidic salts, e.g., stearates and laurates; etc.

The acrylic rubber preferably includes the cross-linking promoter in an amount of from 0.1 to 20 parts by weight, and more preferably from 0.3 to 10 parts by weight. When too much, the cross-linking speed is too high, the rubber has bloom of the cross-linking promoter or is too hard. When too little, the rubber noticeably deteriorates in tensile strength, or varies too much in extension or tensile strength after heated.

The acrylic rubber can be prepared by proper mixing methods such as roll mixing, Banbury mixing, screw mixing and solution mixing. After components difficult to react or dissolve with heat are fully mixed, components easy to react or dissolve with heat such as a crosslinker are mixed at a temperature at which they do not react or dissolve in a short time.

The acrylic rubber is preferably heated to be crosslinked at a temperature of from 130 to 220° C., and more preferably from 140 to 200° C. for 30 sec to 5 hrs.

The acrylic rubber is heated by press heating, steam heating, oven heating or hot-air heating to be crosslinked. The acrylic rubber may be crosslinked again such that even an inside thereof is crosslinked, preferably for 1 to 48 hrs, depending on heating methods, temperatures and shapes of the rubbers.

To the above-mentioned materials, an electric resistance regulator regulating electric properties and a flame retardant imparting flame resistance, and optional materials such as an antioxidant, a stiffener, a filler and a cross-linking promoter are included.

The above-mentioned electric resistance regulators can be used. However, it is preferable not to use too much of carbon black or metal oxides because of impairing flexibility. Ion conductive agents or conductive polymers are effectively used. These may be combined.

Specifically, the rubber preferably includes various perchlorates or ionic liquids in an amount of from 0.01 to 3 parts by weight. When less than 0.01 parts by weight, the resistivity is not effectively decreased. When greater than 3 parts by weight, the conductive agents possibly blooms or bleeds on the surface of the belt. The elastic layer preferably has a surface resistivity of from 1×10⁸ to 1×10¹³ [Ω/□] and a volume resistivity of from 1×10³ to 1×10¹² [Ω/□].

In order to obtain high transferability onto concave and convex papers, required for the recent electrophotographic image forming apparatuses, the elastic layer 12 preferably has a micro rubber hardness not greater than 35 in an environment of 23° C. 50% RH.

Martens or Vickers hardness is a fine hardness which is a hardness of a shallow area in a bulk direction, i.e., a hardness of only the very surface. When a soft material is applied to the surface of an intermediate transfer belt even having low transformability, fine hardness is still low. Therefore, the micro rubber hardness is preferably measured to evaluate transformability of the whole belt.

The elastic layer 12 preferably has a thickness of from 200 μm to 2 mm, and more preferably from 400 to 1,000 μm. When too thin, followability and transfer pressure reduction to the surface of a transfer medium are low. When too thick, the belt is easy to bow and unstably runs, and a flexed position thereof at a roller is easy to have a crack. The thickness can be measured by observing the cross-section with an SEM.

Next, the spherical particulate resin 13 formed on the elastic layer 12 is explained. The spherical particulate resin 13 is insoluble in organic solvents, and has the shape of a sphere, an average particle diameter not greater than 100 μm and a 3% decomposition temperature not less than 200° C.

Main components thereof include acrylic resins, melamine resins, polyamide resins, polyester resins, silicone resins, fluorine-containing resins, etc. They may be surface-treated with different materials. A hard resin may be coated on a spherical particulate material formed of a rubber. Further, they may be hollow or porous. Among these resins, silicone resins are most preferably used because of having lubricity, and imparting releasability and abrasion resistance to a toner. These resins are preferably spheronized by polymerization methods, etc. The closer to sphericity, the better in this embodiment.

The spherical particulate resin 13 is preferably a monodispersion particulate material having a volume-average particle diameter of from 1.0 to 5.0 μm. The monodispersion particulate material is not a particulate material having a unified particle diameter, but a particulate material having a very sharp particle diameter distribution. Specifically, the distribution width is preferably ±average particle diameter×0.5 μm. When less than 1.0 μm, transferability is not sufficiently improved. When greater than 5.0 μm, gaps between particles are so large that a toner is not transferred well and the belt is not cleaned well. Further, having high insulativity, the particles having too large a particle diameter cause residual potential, resulting in image distortion due to accumulation of the potential when images are continuously produced.

The spherical particulate resin 13 is not particularly limited, synthetic resins and marketed resins may be used. Specific examples of the marketed resins include silicone particulate resins Tospearl® 120. 145 and 2000B from Momentive Performance Materials, Inc.; and acrylic particulate resins Techpolymer MBX-SS from Sekisui Plastics Co., Ltd., etc.

The spherical particulate resin 13 is directly coated on the elastic layer 12 in the form of a powder and smoothed to be uniformly lined up. The spherical particulate resin 13 can be coated thereon before or after the rubber is crosslinked.

Next, the surface status of the belt in this embodiment is explained. FIG. 5 is an amplified schematic view illustrating the intermediate transfer belt viewed from straight above. The spherical particulate resins 13 having a uniform particle diameter are independently lined up in order. They are scarcely overlapped. The spherical particulate resins 13 preferably have cross-sections having a uniform particle diameter at the resin layer surface as well, specifically a distribution width not greater than ±average particle diameter×0.5 μm. They preferably have a uniform particle diameter, but those having a specific particle diameter may selectively be formed at the surface to have the distribution width.

As for a projection area ratio between an exposed part of the elastic layer 12 and that of the spherical particulate resin 13, the exposed part of the spherical particulate resin 13 preferably has a projection area ratio not less than 60%. When less than 60%, the exposed area of the elastic layer 12 without being covered with the spherical particulate resin 13 is so large that a toner and the elastic layer 12 contact each other, resulting in poor transferability of the toner, and noticeable deterioration of cleanability of the residual toner and filming resistance of the toner.

In this embodiment, the spherical particulate resin 13 is partially buried in the elastic layer 12. The burial rate is preferably greater than 50% and less than 100%, and more preferably from 51 to 90%. When not greater than 50%, the spherical particulate resin 13 is likely to release from the belt when used for long periods, resulting in deterioration of durability. When 100%, the spherical particulate resin 13 has no effect for transferability.

The burial rate is a rate of diameter of the spherical particulate resin 13 buried in the elastic layer 12 in a depth direction. All the spherical particulate resins 13 do not have to have a burial rate greater than 50% and less than 100%. The burial rate may be greater than 50% and less than 100% on average. When the burial rate is 50%, the spherical particulate resins 13 completely buried in the elastic layer is scarcely seen when the cross-section is observed by an SEM. The spherical particulate resins 13 completely buried in the elastic layer is not greater than 5% by number per 100% by number thereof.

The spherical particulate resins 13 are preferably lined up on the elastic layer 12 in its surface direction, and further formed in a single layer in a depth direction of the elastic layer 12. When plural particles are included in the thickness direction, they are unevenly distributed and electrical properties of the belt surface become uneven due to electric resistance of the particles, resulting in image disorder. Specifically, a part where many particles are present has high electric resistance and a surface potential due to a residual charge, the surface potential on the belt surface varies, and adjacent parts differ in image density, resulting in obvious image disorder.

Next, a method of preparing an intermediate transfer belt used in this embodiment is explained.

First, a method of preparing the substrate layer 11 of the intermediate transfer belt is explained.

A method of preparing the substrate layer 11 with a coating liquid including at least a resin component, i.e., the polyimide or polyamideimide resin precursor is explained.

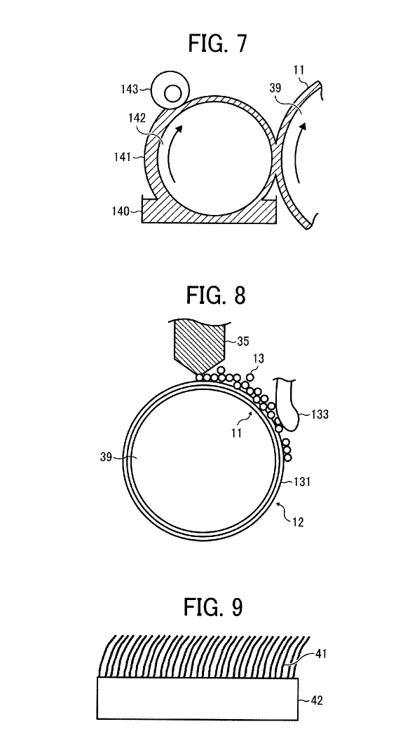

A coating liquid including the polyimide or polyamideimide resin precursor is coated on the surface of a cylindrical substrate (die) by spiral coating with a nozzle or a dispenser, die coating with a wide die, roll coating with a roll, etc. The rolling coating is explained. FIG. 7 is an embodiment of the roll coating apparatus. A coating liquid pan 140 reserves the defoamed precursor liquid, i.e. a coating liquid 141. A coating roller 142 continuously draws the coating liquid 141 from the coating liquid pan 140. A regulation roller 143 adjusts the thickness of the continuously drawn coating liquid 141 in a gap with the coating roller 142 to have a predetermined thickness. The coating liquid 141 having a predetermined thickness is transferred from the coating roller 142 to a cylindrical substrate (die) 39.

The coating liquid 141, i.e., a fully defoamed precursor liquid is poured into the coating liquid pan 140. The coating liquid is preferably has a viscosity of from 0.5 to 10 Pa·s with an organic polar solvent. Next, the coating liquid pan 140 in which the coating liquid 141 is poured is put close to a lower part of the coating roller 142 to be dipped in the coating liquid, and the coating liquid 141 is applied to the surface of the coating roller and drawn upward at low peripheral speed of from 10 to 100 mm/sec. Then, the regulation roller 143 located above the coating roller 142 capable of having a desired gap therewith adjusts the thickness of the coating liquid thereon. The thickness is preferably twice as large as a thickness of the coating liquid transferred onto the cylindrical substrate 39.

The cylindrical substrate 39 is coated while rotated slowly such that the coating liquid thereon has a thickness not greater than that on the coating roller 142. The coating liquid 141 on the coating roller 142 is transferred onto the cylindrical substrate 39 rotating in the same direction as that of the coating roller 142 (clockwise in FIG. 7) to have a predetermined thickness thereon.

After coated, the cylindrical substrate 39 is gradually heated while rotated to evaporate a solvent in the coated film at from about 80 to 150° C. A vapor such as volatilized solvent in the atmosphere is preferably removed while efficiently circulated. When a self-supporting film is formed, the cylindrical substrate 39 is placed in a high-temperature processable heating furnace (firing furnace) together with the die. The cylindrical substrate 39 is gradually heated and finally processed (fired) at high temperature of from 250 to 450° C., and the polyimide resin precursor or the polyamideimide precursor is imidized or polyamideimidized to form a substrate layer 11.

After the substrate layer 11 is fully cooled, an elastic layer 12 is layered in the substrate layer 11. A rubber coating material in which a rubber is dissolved in a solvent is coated on the substrate layer 11, and the solvent is dried and vulcanized to form the elastic layer 12 thereon. Existing coating methods such as spiral coating, die coating and roll coating can be used as they are to form the substrate layer 11. The elastic layer 12 needs to have a thick thickness to improve concave and convex transferability, and the die coating and the spiral coating are preferably used to form a thick film. The spiral coating is explained. While a rubber coating material is continuously applied by a circular or a wide nozzle to the substrate layer 11 while rotated in its circumferential direction, the nozzle is moved in an axial direction of the substrate layer 11 to spirally coat the coating material thereon. The coating material spirally coated on the substrate layer 11 is dried while leveled by keeping the rotational speed and drying temperature.

When fully leveled, as FIG. 8 shows, a powder feeder 35 and a pressing member 133 are placed to uniformly place the spherical particulate resins 13 on the surface of the cylindrical substrate 39 while rotated from the powder feeder 35. Then, the pressing member 133 presses the spherical particulate resins 13 placed on the surface at a specific pressure. The pressing member 133 buries the spherical particulate resins 13 in a belt 131 coated with the substrate layer 11 and the elastic layer 12 supported by the cylindrical substrate 39 while removing extra spherical particulate resins 13 therefrom. In this embodiment, since a monodispersion spherical particulate resin 13 is used, such a simple process with the pressing member 133 can form a uniform unified particle layer.

The burial rate of the spherical particulate resin 13 in the elastic layer 12 may be controlled by other methods, and can easily be controlled by increasing or decreasing a pressure of the pressing member 133. Although depending on the viscosity of the coating liquid, the content of the resin, an amount of the solvent used and the resin quality, the burial rate is greater than 50% and less than 100% when the coating liquid has a viscosity of from 100 to 10,000 mPa·s and the pressure is from 10 to 1,000 mN/cm only as a guide.

After a uniform particle layer is formed, the elastic layer 12 the spherical particulate resins 13 is buried in is hardened and formed when heated at a predetermined temperature and a predetermined time while the cylindrical substrate 39 is rotated. After fully cooled, the belt 131 is released from the cylindrical substrate 39 to prepare a desired intermediate transfer belt as a seamless belt.

Methods of measuring the burial rate of the spherical particulate resin 13 include, but are not limited to, observing the cross-section of the intermediate transfer belt by an SEM.

Methods of measuring the projection area ratio of an exposed part of the spherical particulate resin 13 on the intermediate transfer belt include, but are not limited to, observing the surface of the intermediate transfer belt by an SEM to take a picture image and digitalizing the image with an image processing software (Image-Pro Plus from Media Cybernetics, Inc.) to determine the projection area ratio of an exposed part of the elastic layer 12 and an exposed part of the spherical particulate resin 13.

The resistivity of the thus prepared intermediate transfer belt is controlled by changing the amounts of carbon black and ion conducting agent. The resistivity is likely to change according to the size of particle and an occupation area thereof. Marketed measurers such as Hiresta from Dia Instruments Co., Ltd. can be used to measure the resistivity.

The thus prepared seamless belt is preferably used as an intermediate transfer belt used in image forming apparatus using intermediate transfer method, which produces high-quality images.

The intermediate transfer belt has been explained as an embodiment, but other belts such as a photoreceptor belt and a recording medium conveying belt used in image forming apparatus can have the same constitution as that of the intermediate transfer belt. The other belts having the same constitution, used in image forming apparatus have the same effects.

Next, a contactor contacting the surfaces of both ends of the intermediate transfer belt in its width direction is explained. Contactors such as a toner seal member preventing a toner from scattering and a curl preventing member preventing the intermediate transfer belt from curling contact the surface of the end of the intermediate transfer belt in its width direction.

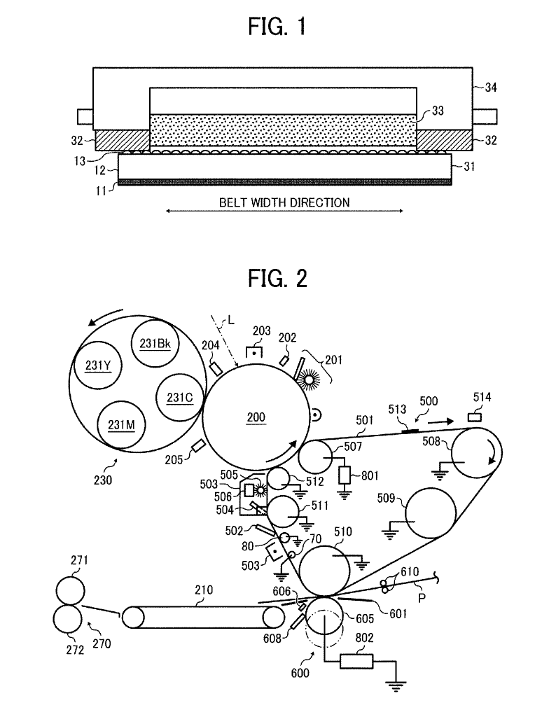

FIG. 1 is a schematic view illustrating a cleaning unit 34 including a toner seal member 32 contacting the surfaces of both ends of the intermediate transfer belt 31 in its width direction.

The cleaning unit 34 in FIG. 1 is applicable the belt cleaners 503 and 29 in FIGS. 2 and 3, respectively.

A chassis of the cleaning unit 34 includes a cleaning member 33 removing materials adhering to the surface of the intermediate transfer belt 31 to clean the surface thereof and the toner seal member 32 located beyond the cleaning member 33 in the width direction of the belt. Known cleaning blades or cleaning brushes can be used as the cleaning member 33.

The toner seal member 32 contacts surfaces of both ends of the intermediate transfer belt 31 in this width direction. This prevents a material having adhered to the surface of the intermediate transfer belt 31, which is removed by the cleaning member 33 from leaking from a gap between the cleaning member 33 and the intermediate transfer belt 31 when the surface thereof is cleaned by the cleaning member 33. In this embodiment, the toner seal members 32 located at both ends of the cleaning unit 34 in its width direction works as a curl prevention member preventing the end of the intermediate transfer belt 31 from curling.

In order to obtain high transferability to concave and convex papers, the elastic layer of the intermediate transfer belt preferably has high transformability, i.e., low micro rubber hardness. However, when the intermediate transfer belt has high transformability, i.e., low micro rubber hardness, the both ends thereof in its width direction are likely to abrade or scrape due to friction with the toner seal member 32. The present inventors found that the toner seal member 32 having a hardness not greater than 30 when measured by Durometer Type C at 23° C. and 50% RH does not cause or largely decreases abrasion of the intermediate transfer belt 31 in its width direction even when they are frictionized with each other for a long time. It is thought this is because a soft contact member having low hardness decreases its load to the intermediate transfer belt.

The contact member such as a toner seal member 32 in this embodiment preferably has a layered constitution formed of a surface layer 41 including a sheet and resin fiber implanted therein and a foam layer 42 formed of a foam such as a sponge as shown in FIG. 9. The surface layer 41 contacting the intermediate transfer belt has slidability therewith. When the contact member is used as a toner seal member 32, the surface layer 41 has god toner sealability. The foam layer 42 has flexibility to sufficiently decrease a load to the intermediate transfer belt.

The resin fiber of the surface layer 41 is formed of known resin fiber materials such as nylon, rayon, polyurethane, acryl, polyolefin, PPS, PTFE, M aramid and PET. Further, the resin fiber contacting the intermediate transfer belt may be treated with fluorine or silicone for the purpose of improving slidability therewith.

The foam layer 42 is formed of foams having sufficient flexibility (hardness not greater than 30 when measured by Durometer Type C) needed in this embodiment such as polyurethane foam, polyethylene foam, polystyrene foam, polypropylene foam, ethylene-vinylacetate copolymer (EVA) foam, polyvinylchloride (PVC) foam, chloroprene rubber foam, nitrile rubber foam, acrylic rubber foam and EPDM rubber foam.

The foam layer 42 preferably has a thickness of from 0.5 to 30.0 mm, and more preferably from 1.0 to 10.0 mm. When too thin, the foam cannot absorb a load due to contact to the intermediate transfer belt and is affected by hardness of the chassis the contact member is attached to even when having sufficient flexibility. When too thick, the image forming apparatus is not downsized, resulting in cost increase.

The hardness of the contact member is measured by a method according to durometer hardness test (Durometer Type C test) disclosed in JIS K 7312.

The contact member in this embodiment having a thickness not greater than 10 mm is preferably used, and therefore plural contact members are overlapped until having a thickness greater than 10 mm to measure the thickness.

### EXAMPLES

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### <Intermediate Transfer Belt>

Intermediate transfer belts A to E used in each Example and Comparative Example were prepared.

### [Intermediate Transfer Belt A]

A substrate layer coating liquid was prepared as follows, and a seamless belt substrate layer is formed therewith.

### <Preparation of Substrate Layer Coating Liquid>

First, carbon black (Special Black 4 from Evonik-Degussa Corp.) was dispersed in N-methyl-2-pyrolidone by a beads mill to prepare a dispersion. The dispersion was mixed with a polyimide varnish including a polyimide resin precursor as a main component (U-Varnish A from Ube Industries, Ltd.) such that the content of the carbon black has 17% by weight of a solid content of polyamic acid to prepare a coating liquid.

### <Preparation of Seamless Belt>

Next, a metallic cylindrical substrate having an outer diameter of 340 mm and a length of 360 mm, the surface of which was blasted to be rough was set on a roll coat coater as a die.

Next, the substrate layer coating liquid was poured in a pan and drawn up by a coating roller at 40 mm/sec. The thickness of the coating liquid on the coating roller was controlled with a gap of 0.6 mm between a regulation roller and the coating roller.

The cylindrical substrate rotating at 35 mm/sec was brought close to the coating roller with a gap of 0.4 mm to uniformly transfer the coating liquid on coating roller onto the cylindrical substrate. Then, the coated cylindrical substrate was placed in a circulating hot air drier while rotated at 35 mm/sec and gradually heated at 110° C. for 30 min, and further heated at 200° C. for 30 min, and the rotation was stopped. Then, the coated cylindrical substrate was placed in a high-temperature firing furnace, and heated in stages at 320° C. for 60 min to prepare a substrate layer having a thickness of 80 μm.

### <Preparation of Elastic Layer on Substrate Layer>

The following materials were mixed by a biaxial kneader to prepare a rubber composition.

### <Elastic Layer Material>

| | |
|---|---|
| Acrylic rubber | 100 |
| Nipol AR12 from Zeon Corp. | |
| Stearic acid | 1 |
| Beads stearic acid TSUBAKI from NOF Corp | |
| Red phosphorus | 10 |
| NOVA EXCEL 140F from RIN KAGAKU KOGYO Co., Ltd. | |
| Aluminum hydroxide | 50 |
| Higilite ® H42M from SHOWA DENKO K.K. | |
| Crosslinker | 0.6 |
| Diak. No1 (hexamethylenediamine carbamate) from DuPont Dow | |
| Elastomers Japan K.K. | |
| Cross-linking promoter | 1 |
| VULCOFAC ACT55 (a salt of 1,8-diazabicyclo(5, 4, 0)undecane-7 | |
| and diaicd/amorphous silica = 7/3) from Safic Alcan group | |
| Conducting agent | 0.3 |
| QAP-01 (tetrabutylammonium perchlorate) from Japan Carlit Co., Ltd. | |

Next, the thus prepared rubber composition was dissolved in an organic solvent (methylisobutylketone) to prepare a rubber solution including a solid content of 35% by weight. The rubber solution was continuously coated on the polyimide substrate layer on the cylindrical substrate while rotated in a spiral manner through a nozzle travelling in an axial direction of the substrate. The rubber solution was coated in such an amount as the coated film has a final thickness of 600 μm.

Next, the surface of the elastic layer was evenly dusted with a silicone particulate resin (Tospearl® 120 from Momentive Performance Materials, Inc.) having a volume-average particle diameter of 2.0 μm as a spherical particulate resin, using the apparatus in FIG. 7. Then, a pressing member, i.e., a polyurethane rubber blade pressed the silicone particulate resin to be fixed in the elastic layer. The pressure was 100 mN/cm.

After the whole surface of the belt was treated, the cylindrical substrate the rubber coating was coated on was placed in a circulating hot air drier while rotated, and heated up to 170° C. at 4° C./min for 60 min. After heated, the rubber coating was cooled to have a room temperature and taken out from the die to prepare an intermediate transfer belt A.

### [Intermediate Transfer Belt B]

The procedure for preparation of the intermediate transfer belt A was repeated to prepare an intermediate transfer belt B except for replacing the elastic layer materials with the following materials.

### <Elastic Layer Material>

| | |
|---|---|
| Hydrogenated nitrile rubber | 100 |
| Zetpol 2020L from Zeon Corp. | |
| Stearic acid | 1 |
| Sulfur | 1 |
| 200 mesh sulfur from TSURUMI CHEMICAL INDUSTRY CO., LTD | |
| Zinc oxide | 5 |
| Rubber accelerator | 0.5 |
| NOCCELER TS (tetramethylthiuram monosufide from OUCHI | |
| SHINKO CHEMICAL INDUSTRIAL CO., LTD., | |
| Red phosphorus | 10 |
| NOVA EXCEL 140F from RIN KAGAKU KOGYO Co., Ltd. | |
| Aluminum hydroxide | 40 |
| Higilite ® H42M from SHOWA DENKO K.K. | |
| [Intermediate Transfer Belt C] | |

The procedure for preparation of the intermediate transfer belt A was repeated to prepare an intermediate transfer belt C except for changing the elastic layer materials and the process of preparation of the elastic layer coating liquid as follows.

First, 70 parts of the aluminum hydroxide and 20 parts of the red phosphorus were added to a main material RUP-1627 (blocked isocyanate) of a urethane resin (Urehyper) from DIC Corp. to prepare mixture. Then, 20 parts of DMF (dimethylformamide) as a viscosity-adjustment solvent were added thereto, and the mixture was well stirred to disperse the additives therein. Next, 10 parts of a hardener CLH-5 (amine hardener) were added to the mixture, and stirred and mixed to prepare a urethane rubber coating liquid.

### [Intermediate Transfer Belt D]

The procedure for preparation of the intermediate transfer belt A was repeated to prepare an intermediate transfer belt D except for not forming the elastic layer.

### <Toner Seal Member (Contact Member)>

Toner seals a to f used in each Examples and Comparative Example were prepared as follows.

### [Toner Seal Member a]

A foam layer formed of an ester polyurethane foam (SM-55 from INOAC Foam Company) having a thickness of 3.4 mm was prepared. A fiber-planted surface layer was formed on the foam layer using a fluorine-containing resin fiber (TOYOFLON® from Toray Industries, Inc.) to prepare a toner seal member a.

### [Toner Seal Member b]

The procedure for preparation of the toner seal member a was repeated to prepare a toner seal member b except for not forming the fiber-planted surface layer.

### [Toner Seal Member c]

The procedure for preparation of the toner seal member a was repeated to prepare a toner seal member c except for forming the foam layer having a thickness of 0.4 mm.

### [Toner Seal Member d]

The procedure for preparation of the toner seal member a was repeated to prepare a toner seal member d except for forming the foam layer formed of a CR rubber foam (RUBAPELCA CR-250CN from SANWA KAKO CO., LTD.) having a thickness of 4.0 mm.

### [Toner Seal Member e]

The procedure for preparation of the toner seal member a was repeated to prepare a toner seal member e except for forming the foam layer formed of an EPDM rubber foam (RUBAPELCA EP-130 from SANWA KAKO CO., LTD.) having a thickness of 2.5 mm.

### [Toner Seal Member f]

The procedure for preparation of the toner seal member a was repeated to prepare a toner seal member f except for replacing the foam layer with a PET board having a thickness of 1.5 mm.

The intermediate transfer belts A to D and the toner seal members a to f were installed in the image forming apparatus in FIG. 3 by combinations in Tables 1-1 to 1-3 to make Examples 1 to 7 and Comparative Examples 1 and 2.

Image quality (cyan and magenta toner transferability) on a concave and convex paper (Lezac 260 [kg]) produced by the image forming apparatus of each Example and Comparative Example was visually evaluated. Fair means slightly poor, but usable. Poor means unusable because concave parts had low image density, and uneven image density, hollow images and image distortion occurred. Then, 200,000 images were continuously produced to do the same image evaluation.

In addition, toner sealability after 200,000 images were produced was evaluated. Excellent means toner scarcely leaked. Fair means toner slightly leaked, but usable. Poor means toner leaked much, and unusable.

Further, an abrasion status of an end of the intermediate transfer belt after 200,000 images were produced was visually evaluated. Excellent means almost no abrasion. Fair means slight abraded, but usable. Poor means abraded much, and unusable.

The initial hardness measured by Durometer Type C of each toner seal member in an environment of 23° C. and 50% RH was measured by a method specified in JIS K7312. As a durometer, JIS C type rubber hardness meter GS-701N from TECLOCK Corp was used, and rubber hardness meter constant loader GS-710 from TECLOCK Corp was used as a stand to avoid uneven measurement by measurers.

Three toner seal members a, b and d, 25 toner seal members c and 4 toner seal members e were overlapped to have a total thickness not less than 10 mm to measure.

The initial micro rubber hardness of an effective image area in the center of the belt in its width direction and an area out of the effective image area 1.0 cm from an end of the belt in its width direction were measured by a micro rubber hardness meter MD-1 from KOBUNSHI KEIKI CO., LTD.

The results are shown in Tables 1-1 to 1-3.

TABLE 1-1

| | Intermediate Transfer Belt | | |
|---|---|---|---|
| | | | Micro rubber |
| | | Elastic material | hardness |
| Example 1 | A | Acrylic rubber | 31.4 |
| Example 2 | A | Acrylic rubber | 31.4 |
| Example 3 | A | Acrylic rubber | 31.4 |
| Example 4 | B | Nitrile rubber | 55.7 |
| Example 5 | C | Urethane rubber | 58.1 |
| Example 6 | A | Acrylic rubber | 31.4 |
| Example 7 | A | Acrylic rubber | 31.4 |
| Comparative Example 1 | A | Acrylic rubber | 31.5 |
| Comparative Example 2 | D | None | — |

TABLE 1-2

| | Toner Seal Member | | | | |
|---|---|---|---|---|---|
| | | | Durometer | Foam thickness | Fiber-planted |
| | | Foam | hardness | (mm) | surface |
| Example 1 | a | Polyurethane | 22.0 | 3.4 | Yes |
| Example 2 | b | Polyurethane | 22.0 | 3.4 | No |
| Example 3 | c | Polyurethane | 22.0 | 0.4 | Yes |
| Example 4 | a | Polyurethane | 22.0 | 3.4 | Yes |
| Example 5 | a | Polyurethane | 22.0 | 3.4 | Yes |
| Example 6 | d | CR rubber | 25.5 | 4.0 | Yes |
| Example 7 | e | EPDM rubber | 13.5 | 2.5 | Yes |
| Comparative | f | None | 90.0 | — | Yes |
| Example 1 | | | | | |
| Comparative | a | Polyurethane | 22.0 | 3.4 | Yes |
| Example 2 | | | | | |

TABLE 1-3

| | Image Quality | | Toner sealability | End abrasion |
|---|---|---|---|---|
| | Initial | 200,000 | after 200,000 | after 200,000 |
| Example 1 | Excellent | Excellent | Excellent | Excellent |
| Example 2 | Excellent | Good | Fair | Fair |
| Example 3 | Excellent | Good | Fair | Fair |
| Example 4 | Fair | Fair | Excellent | Excellent |
| Example 5 | Fair | Fair | Excellent | Excellent |
| Example 6 | Excellent | Excellent | Excellent | Excellent |
| Example 7 | Excellent | Excellent | Excellent | Excellent |
| Comparative | Excellent | Poor | Poor | Poor |
| Example 1 | | | | |
| Comparative | Poor | Poor | Excellent | Excellent |
| Example 2 | | | | |

In each of Examples 1 to 7, even after 200,000 images were produced, good image quality and toner sealability were maintained, and abrasion of both ends of the intermediate transfer belt in its width direction was prevented.

Comparative Example 1 using the toner seal member f having no foam layer, high type E durometer hardness and poor flexibility initially produced quality images. However, as it was used for longer periods, the elastic layers of both ends of the intermediate transfer belt in its width direction abraded very much. Therefore, abrasion dust of the elastic layer adhered onto a photoreceptor to cause abnormal images such as white spot images, and the belt unstably travelled to cause distorted images, resulting in inability of long period of use.

Comparative Example 2 using the intermediate transfer belt D having poor concave and convex paper followability without an elastic layer did not have abrasion of the elastic layers of both ends thereof in its width direction and poor toner sealability even after used for long periods. However, having poor concave and convex paper followability, quality images could not be obtained from the beginning

The present invention provides a highly-durable image forming apparatus producing high-quality images, having high transferability regardless of transfer materials without abrasion of elastic layers of both ends of an intermediate transfer belt in its width direction.

The present invention includes the following embodiments as well.

### Embodiment A

An image forming apparatus including a belt member such as an intermediate transfer belt 31 including a substrate layer 11 and an elastic layer 12 layered thereon, an image forming means such as an image former 18 forming an image on the surface of the belt member or a recording material borne thereon, and a contact member such as a toner seal member 32 contacting the surfaces of both ends of the belt member in its width direction, in which the contact member has a hardness not greater than 30 when measure by Durometer Type C in an environment of 23° C. and 50% RH.

### Embodiment B

In the embodiment A. a cleaner such as a cleaning member 33 removing materials such as a toner adhering to the surface of the belt member is further included. The contact member is a seal member preventing the materials removed by the cleaner from the surface of the belt member from leaking from a gap between the cleaner and the belt member.

### Embodiment C

In the embodiments A and B, the contact member prevents the both ends of the belt member in its width direction from curling.

### Embodiment D

In the embodiments A, B or C, the belt member has a micro rubber hardness not greater than 35 in an environment of 23° C. and 50% RH.

### Embodiment E

In the embodiments A, B, C or D, the elastic layer includes at least an acrylic rubber.

### Embodiment F

In the embodiments A, B, C, D or E, the elastic layer includes an elastic material and a spherical particulate resin to fonts concavities and convexities on the surface thereof, and the spherical particulate resins are located in a surface direction on the surface of the elastic layer.

### Embodiment G

In the embodiments A, B, C, D, E or F, the contact member includes at least a foam.

### Embodiment H

In the embodiments A, B, C, D, E or F, the contact member includes at least a fiber-planted surface layer 41 formed of a seat member and a resin fiber planted therein and a foam layer 42 formed of a foam.

### Embodiment I

In the embodiments G or H, the foam has a thickness of from 0.5 to 30 mm.

### Embodiment J

In the embodiments A, B, C, D, E, F, G, H or I, the belt member is preferably used as a seamless belt.

Having now fully described the invention, it will be apparent to one of ordinary skill in the art that many changes and modifications can be made thereto without departing from the spirit and scope of the invention as set forth therein.

What is claimed is:

1. An image forming apparatus, comprising:
a belt member, comprising:
a substrate; and
an elastic layer overlying the substrate,
an image former configured to form an image on the surface of the belt member or a recording material borne thereon, and
a contact member configured to contact the surfaces of both ends of the belt member in its width direction,
wherein the contact member has a hardness not greater than 30 when measured by Durometer Type C in an environment of 23° C. and 50% RH.

2. The image forming apparatus of claim 1, further comprising a cleaner configured to remove a material adhering to the surface of the belt member, wherein the contact member is a seal member preventing the material removed therefrom from leaking from a gap between the cleaner and the belt member.

3. The image forming apparatus of claim 1, wherein the contact member prevents the both ends of the belt member in its width direction from curling.

4. The image forming apparatus of claim 1, wherein the belt member has a micro rubber hardness not greater than 35 in an environment of 23° C. and 50% RH.

5. The image forming apparatus of claim 1, wherein the elastic layer comprises an acrylic rubber.

6. The image forming apparatus of claim 1, wherein the elastic layer comprises an elastic material and spherical particulate resins to form concavities and convexities on the surface thereof, and the spherical particulate resins are located in a surface direction on the surface of the elastic layer.

7. The image forming apparatus of claim 1, wherein the contact member comprises a foam.

8. The image forming apparatus of claim 1, wherein the contact member comprises:
a fiber-planted surface layer formed of a seat member and a resin fiber planted in the seat member; and
a foam layer formed of a foam.

9. The image forming apparatus of claim 7, wherein the foam has a thickness of from 0.5 to 30 mm.

10. The image forming apparatus of claim 1, wherein the belt member is a seamless belt.
